(19) United States
(12) Patent Application Publication
(10) Pub. No.: US 2009/0201259 A1
(43) Pub. Date: Aug. 13, 2009

(54) Cursor creation for touch screen

(75) Inventor: Juha H-P Nurmi, Salo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/069,447

(22) Filed: Feb. 7, 2008

(51) Int. Cl. G06F 3/041

(52) U.S. Cl. 345/173

(57) ABSTRACT

Quick cursor creation is obtained by providing touch detection information of at least one pixel cell to a source driver at the time when pixel information of the pixel cell is updated and updating pixel information of the pixel cell within a pixel output buffer depending on the touch detection information at the time when the pixel information is updated.

### TECHNICAL FIELD

This specification relates to quick creation of a cursor within a touch screen.

### BACKGROUND

Within portable information terminals, for example PDAs, laptops, tablet PCs, video players, music players, multimedia players, cameras, mobile phones, and the like, touch screens for receiving user input are emerging into the market.

Touch screens for receiving user input may be understood as touch sensible input screens, which are arranged to detect a user input from depressing a screen which displays user information. Touch screens may be a combination of a display arranged below a touch sensitive sheet, which is capable of sensing the location of contact with a finger or a pen. Also, touch screens may be a combination of a display arranged with a touch sensitive switch matrix, e.g. a display integrated touch screen, which is capable of sensing the location of contact with a finger, a pen or any other object. A touch screen may receive user inputs, for example pressing a button or an icon, or selecting certain areas, writing memos, selecting programs, and the like within a user interface of a computer program.

In order to process the user input, a microprocessor, e.g. a drive engine, which is responsible for the operation of the portable information terminal, i.e. the computer program running on the terminal, needs to receive the detected user inputs and convert them into the appropriate program instructions. In order to receive the user inputs, the drive engine responsible for the operation of the information terminal needs to receive the signals from the touch screen, and to convert these signals into the appropriate program logic.

The drive engine may operate, besides the touch screen, also loudspeakers, transmission and reception antennas and modules, for example for wireless communication, e.g. GSM, UMTS, WiFi, Near Field Communication (NFC), Bluetooth and the like, keyboards, global positioning devices (GPS), microphones, camera devices, display devices, multimedia processors, and the like. All of these devices may be operated by the drive engine and the interoperation between the devices is controlled by the drive engine.

In case the drive engine is required to process signals from the touch screen, the touch screen engine may issue an interrupt for the drive engine. Upon reception of the interrupt, the drive engine may dedicate at least a part of its processing power to the touch screen and/or the touch screen engine in order to receive and process the signals received from the touch screen and/or the touch screen engine. When receiving the interrupt from the touch screen engine, the drive engine may be activated, and a cursor may be created.

Cursor creation may comprise creating within the display an icon representing to the user that input is possible at the respective location. A cursor may, for example, be a blinking vertical line. Further, a cursor may be an arrow, which can be moved within the display by user interaction. Cursor creation is important, as a cursor indicates the user that the device is working properly. When the user does not see any cursor, he might think that the device is out of order. Thus, a quick response by the device by way of showing a cursor increases the trust of the user in the correct operation of the device. Latency in cursor creation should be avoided. Any latency might lead to the user's impression that there is something wrong with the device.

### SUMMARY

According to one aspect of the specification, there is provided a method comprising providing touch detection information of at least one pixel cell at a time when pixel information of the cell is updated, and updating pixel information of the pixel cell depending on the touch detection information at the time when the pixel is updated.

For example, touch detection information may be provided by any suitable means, for example touch sensors, i.e. capacitive, resistive or optical touch detection sensors. Touch detection information may contain at least the co-ordinates of a detected touch on the display. Touch detection information may further comprise information about the strength of the touch on the display.

This touch detection information may be provided at the time when pixel information of the pixel cell is updated.

According to embodiments, the touch detection information may be provided to a source driver. A source driver may be implemented within the touch screen panel itself. For example, the source driver may be a driver for driving the pixel cell lines. Receiving within the source driver the touch detection information allows the touch panel itself to update the pixel depending on detected touches.

Pixel information updating may comprise receiving from the drive engine and/or from the display driver information about the display content for a particular pixel within a pixel cell. When the display content changes, the pixels may need to change their brightness/color, and the like. At least the brightness and the color of each pixel cell may be stored in a pixel output buffer, according to embodiments. For example, it may be possible that the display is updated line by line. For example, when a line has 720 pixels, there are 720 pixel output buffers, one for each pixel cell or one output buffer with 720 registers, one for each pixel. When a line is updated, the pixel output buffers are fed with information about at least the brightness and color of each pixel in the line, and this information is further, via the pixel output buffer, transferred to the respective pixel cell. When the next line is updated, the pixel output buffers are re-filled with information for the pixel cells in the next line.

By providing the touch detection information at the time when pixel information of the pixel cell is updated it is already possible to react on detected touches at the time of updating the pixels.

When updating the pixel cells, the content of a pixel output buffer is transferred to the respective pixel cell. In order to reduce the time of cursor creation, it is proposed that the pixel information of the pixel cell, e.g. stored within a pixel output buffer, is updated depending on the touch detection information at the time when the pixel information is updated. When a touch is detected, the pixel output buffer of the corresponding pixel cell where the touch was detected may be altered. For example, it may be possible that at the time when the pixel information is updated, already the pixel information, e.g. stored within the pixel output buffer, is altered such that at least a part of the cursor is already displayed within the respective pixel. The pixel output buffer thus may already be adjusted at the time, when the pixel is updated in order to represent a cursor at the corresponding pixel cell.

It may be possible, to synchronize touch detection and pixel updating, such that at one time instance touch detection is enabled and pixel cells are updated within the same set of pixel cells. For example, it may be possible to provide for a common gate line, activating both touch detection, and pixel updating within the common line. This common gate line may be activated when a line of pixel cells is to be activated. As this common gate line is also connected to the activation of touch detection, touch detection and pixel updating is synchronized.

According to embodiments, synchronizing may comprise combining at least a pixel selection line and a touch detection line within one common gate line. For example, it may be possible, to activate touch detection and pixel updating by activating transistors, for example CMOS transistors with a HIGH signal state of the common gate line. Then, by switching the HIGH states through all common gate lines consecutively, the whole display may be updated and at the same time touch detection may be carried out at the corresponding lines.

Updating the pixel information of the pixel cell within a pixel output buffer may, according to embodiments, comprise changing the pixel information such that the pixels show at least a part of a cursor. For example, a usual color of a pixel may be white. When a touch is detected at the corresponding pixel cell, this color may be changed to black, as a cursor may be a black line. The source driver may comprise logic to change the data in the pixel output buffer such that the cursor is blinking. For example, the change of the pixel output buffer is such that at one time instance the original pixel information is stored and at the next time instance this pixel information is changed to, for example, the color black. This results in a pixel showing consecutively black and white, resulting in a blinking pixel impression.

In order to provide fast cursor creation, the source driver being part of the touch screen panel may comprise additional logic. The source driver may, according to embodiments, be arranged within a non-visible area of the display. The source driver therefore is in the immediate vicinity of the display, e.g. the pixel cells, the common gate lines, the source lines, and read out lines. The source driver may be directly connected to source lines and read out lines for receiving touch detection and also providing pixel information for updating pixel cells.

In some applications, it may be necessary that a cursor is larger than the size of one pixel. For this reason, when a touch is detected at a certain location, cursor creation should be carried out in the direct vicinity of this location. For this reason, embodiments provide changing data, e.g. in the pixel output buffer(s), of at least one neighboring pixel cell of a first pixel cell, when a touch is detected within the first pixel cell. For example, vertical neighboring pixels, for example the next four vertically neighboring pixels may be provided with altered information for cursor creation, when a touch is detected within one first pixel cell. Also, a horizontal cursor may be created by changing the pixel output buffers of horizontally neighboring pixel cells.

It might be necessary to indicate to a user that a touch is detected by showing the user where the device has detected his finger or a pen or any other pointing device. In order to allow the user to see this indication, the cursor should not be hidden by the finger itself. For this reason, it may be possible, that pixel output buffers of pixel cells are changed in a circular vicinity of a first pixel cell, when the touch is detected within the first pixel cell. For example, when a touch is detected, a circular or elliptical vicinity with a distance of 3-20 pixel away from the first pixel cell may be the area where the pixel output buffers are altered for cursor creation. In this way, the user sees the cursor around his finger, even though a touch is detected in the middle of the finger tip.

In some applications, user input is not possible at all locations of the display. It might be required, however, only at input fields. In order to clearly indicate to a user where an input is required when he touches the display, embodiments provide the source driver with information about the pixel cells, where user input is possible, and further change a pixel output buffer of at least one of the first pixel cells which is closest to at least one pixel cell where a touch is detected. The source driver is provided by the engine or by the display driver with information of where user input is possible. When a touch is detected in the vicinity of this area, the source driver creates the cursor not at the location where the touch is detected, but rather at the location of the user input field. In the case, when more user input fields are shown on the display, the source driver needs to decide, within which of these fields the cursor is to be created. For this reason, according to embodiments, the cursor is created in the region which is closest to the pixel cell where the touch was detected.

Further, a cursor may be created with a line shape or an arrow shape, according to embodiments. It may be possible that the pixel output buffers of pixel cells which are spatially arranged according to the cursor shape are changed. For example, when a cursor shape is created, all pixels which are spatially arranged in a cursor shape around the pixel cell where the touch was detected are subject to altering of the pixel output buffer.

A further aspect is an apparatus comprising a touch screen, a driver within the touch screen, wherein the driver is connected to a touch detection sensor, wherein the driver is connected to at least one pixel cell, and wherein the touch detection sensor is read out by the driver at the time when pixel information of the pixel cell is updated, when the source driver is updating pixel information of the pixel cells depending on the touch detection information at the time when the pixel information is updated.

According to a further aspect, a device is provided, comprising touch detection means arranged within pixel cells for detecting touches within the pixel cells, driving means for driving source lines of the touch screen such that the driving means are connected to a touch detection means, wherein the driving means are connected to at least one pixel cell, and wherein the touch detection means are read out by the driving means at the time when pixel information of the pixel cell is updated, wherein the driving means update pixel information of the pixel cell depending on the detected touches at the time when the pixel information is updated.

A further aspect is a computer readable medium having a computer program stored thereon, the computer program comprising instructions operable to cause a processor to provide touch detection information of at least one pixel cell to a driver at a time when pixel information of the pixel cells is updated and to update pixel information of the pixel cell within a storage depending on the touch detection information at the time when the pixel information is updated.

A further aspect is a computer program comprising these instructions.

These and other aspects of the specification will be apparent from and elucidated with reference to the detailed description presented hereinafter. The features of the present specification and of its exemplary embodiments as presented above are understood to be disclosed also in all possible combinations with each other.

### BRIEF DESCRIPTION OF THE DRAWINGS

FIG. 1 a block diagram of a mobile phone with its components;

FIG. 2 a side view of a touch screen;

FIG. 3 schematically a block diagram of a touch screen system;

FIG. 4 schematically a diagram of a touch screen system;

FIG. 5 schematically a display panel with pixel cells;

FIG. 6 a flowchart of a method according to embodiments.

### DETAILED DESCRIPTION OF THE FIGURES

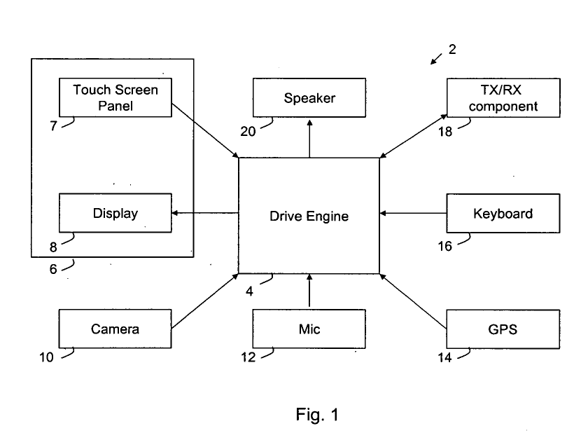

FIG. 1 illustrates schematically a block diagram of a mobile device 2. The mobile device 2 may, according to embodiments, be, for example, a PDA, laptop, tablet PC, video player, music player, multimedia player, camera, mobile phone, or any other user device requiring user inputs.

Depending on which kind of device mobile device 2 is, different appliances and peripherals can be included within a mobile device 2. A selection of possible appliances and peripherals are shown in FIG. 1. It should be noted, that the selection of shown appliances and peripherals is illustrative only and shall not be understood as limiting.

As illustrated in FIG. 1, mobile device 2 is a mobile phone having a drive engine 4. Drive engine 4 may be comprised of hardware and software. Drive engine 4 may be capable of operating all peripherals and any kind of software necessary for operating the peripherals. Drive engine 4 may be a microprocessor, which processes the mobile device 2 according to different standards, applications, and the like. Drive engine 4 may be understood as the core engine of the mobile device 2, which is responsible for the operation and interoperation of programs and appliances, which are hereinafter explained.

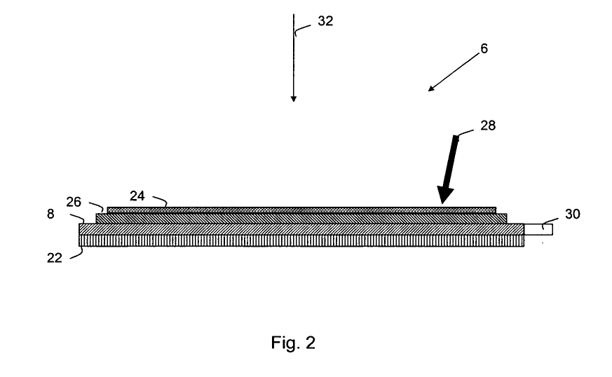

A touch screen 6 may comprise a touch screen panel 7. Touch screen panel 7 may be placed in front of a display panel 8. The touch screen panel 7 may also be incorporated within display panel 8. Touch screen panel 7 may be operated by a touch screen engine, i.e. a touch screen controller (not depicted). Touch screen panel 7 and display panel 8 may be connected to drive engine 4. Touch screen panel may comprise a touch screen controller and may be a component which is for converting physical touches onto its surface or the surface of the display panel 8 into an electrical format, i.e. signals for drive engine 4 for operating programs and other appliances. Touch screen 6 will be further illustrated with reference to FIG. 2.

Spatially beneath touch screen panel 7, a display panel 8 may be arranged. Display panel 8 may be a component, which is for converting electrical information received from the drive engine 4 into a readable format. This information may be any information generated e.g. from a software component for controlling a user interface.

Display panel 8 may be an LED display, OLED display, TFT display, CRT display, plasma display, or any other kind of display capable of converting information into a user readable format. The display panel 8 receives display information from drive engine 4 and puts out this information as optical information.

Further connected to drive engine 4 may be camera 10. The camera 10 may be a component which is for converting image information into a suitable format for further processing by drive engine 4.

Microphone 12 may be a component which is for converting audio information from acoustic waves into electrical information. Microphone 12 may receive user input via acoustic waves and may input these to drive engine 4 in electrical form.

Further, connected to drive engine 4 is GPS receiver 14, which is a component for converting position information, i.e. from satellites into respective position information for drive engine 4.

Further, keyboard 16 may be connected to drive engine 4. Keyboard 16 may be a component which is for converting information from depressed keys into signals for drive engine 4 for receiving user input.

Further connected to drive engine 4 is a transmission and reception component 18. This component 18 may allow for wired and wireless communication with any kind of other communication hardware. For example, GSM and UMTS communication may be possible via component 18. Further, NFC, WiFi, or any other wireless communication may be possible. Component 18 may allow communicating via LAN, WAN or any other wired communication line.

Information from the mobile device 2 may be output via loudspeaker 20. Loudspeaker 20 may be a component for converting electric information into acoustic waves.

The specification relates to the operation of touch screen 6, i.e. touch screen panel 7, display panel 8 and drive engine 4. Cursor creation shall be enhanced by providing touch dependent pixel updating already within the touch screen 6 and/or the display panel 8 without communicating touch information to the engine 4 or between a touch screen controller and a display controller.

Referring now back to FIG. 2, it will be recalled that it illustrates a side view of a touch screen 6 having a display panel 8. Display panel 8 is arranged above a light guide 22 and covered by a protection sheet or sheets 24. Between protection sheet or sheets 24 and display panel 8, there is arranged a touch detection sheet or sheets 26, which enables the touch screen 6, i.e. the touch screen controller, to detect a touch position of, for example, a touch pen 28. The display panel 8 may driven by a display driver 30. Display driver 30 may provide display panel 8 with display information, which is being displayed on display panel 8 and can be seen from a user's viewing direction 32. The display information may be received from the drive engine 4 via a flex-foil connection (not depicted), or any other kind of electrical connection.

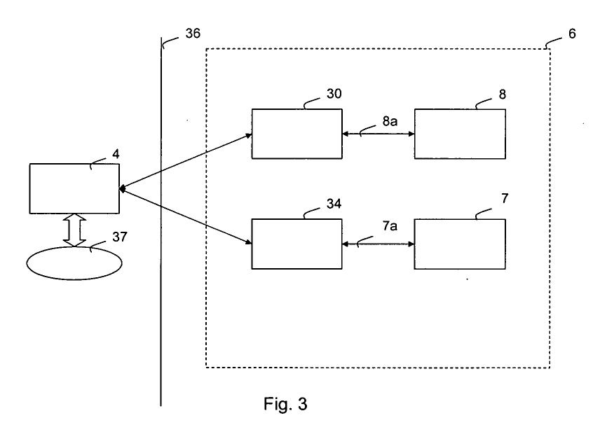

Display panel 8, light guide 22, protection sheet or sheets 24, and touch detection sheet or sheets 26 may in common or in any combination thereof be understood as touch screen 6. Touch screen panel 7 may be comprised of a touch screen engine and touch detection sheet or sheets 26. Touch screen 6 may be connected to the drive engine 4 via an electrical connection, as will be shown in FIG. 3.

Light guide 22 may be connected with a back lighting controller (not depicted) and provides the display panel 8 with back light, so that the content being displayed on display panel 8 and provided through display driver 30 can be seen even in dark viewing conditions.

By means of the touch pen 28, a user may select a certain icon or item being displayed on the display panel 8. This may be done by detecting the press position of pen 28 on touch screen 6 using the touch detection sheet or sheets 26.

The touch detection and position detection is provided by a touch screen controller (not depicted), a.k.a. touch screen driver, being further illustrated in FIG. 3. The touch screen controller 34 may be a microprocessor running a program suitable for controlling the touch screen 6, and/or the touch detection sheet or sheets 26 and for obtaining touch information from touch screen 6 and/or the touch detection sheet or sheets 26.

FIG. 3 illustrates a touch screen 6 with a touch screen panel 7 and a display panel 8. Further illustrated are display controller 30 and touch screen controller 34, which may also be in incorporated within touch screen 6. Touch screen panel 7 is connected to touch screen controller 34 by connection 7a. Display panel 8 is connected to display controller 30 by connection 8a. Touch screen controller 34 and display controller 30 are connected with drive engine 4 via an interface 36.

For usual touch detection and touch interaction, all touch information as well as all display information needs to be transferred via interface 36 from touch screen controller 34 to engine 4 and from engine 4 to display controller 30.

In order to create a cursor on display panel 8, which is located at the co-ordinates, which are detected within touch screen panel 7, the following transfer of information is, according to prior art, necessary.

Touch screen panel 7 detects a touch on touch screen 6 at certain co-ordinates. These co-ordinates are transferred via connection 7a to touch screen controller 34. Within touch screen controller 34, an interrupt is created, which is sent to engine 4. Engine 4, upon reception of the interrupt, is capable of receiving information from touch screen controller 34. Engine 4 indicates to touch screen controller 34 that it is capable of receiving information. Touch screen controller 34 transmits the co-ordinates of the detected touch on touch screen panel 7 to engine 4 via interface 36.

Within engine 4, a software component for processing display information, i.e. the information which is illustrated on the display, as well as cursor information, is calculated. Illustrated schematically only, a cursor function 37 is processed by engine 4. This cursor function 37 is a functionality of engine 4, i.e., to calculate display information for displaying a cursor. A cursor may be a blinking arrow or any other blinking or otherwise animated information indicating to users on display panel 8 the activity of engine 4 and the acceptance of input. Cursor function 37 calculates at the received co-ordinates a cursor to be displayed on display panel 8. After having calculated the cursor information, this information is transferred from engine 4 via interface 36 to display controller 30. Within display controller 30, this cursor is brought into a format for being transferred via connection 8a to display panel 8. Within display panel 8, a cursor is then displayed.

It should be noted that the cursor is created, according to prior art, within engine 4 upon reception of touch co-ordinates. Due to the described process of receiving interrupts, transferring information via different connections, and the like, the creation and display of cursor may take a long time, a. k. a. latency time, that may be disturbing to the user, as the user might think there is something wrong. There is no immediate response from display panel 8 upon touching touch screen panel 7, confusing the user of touch screen 6. Users are used to receive an immediate response from their devices, in particular by seeing the cursor blinking, indicating to the user that everything is in order with the device.

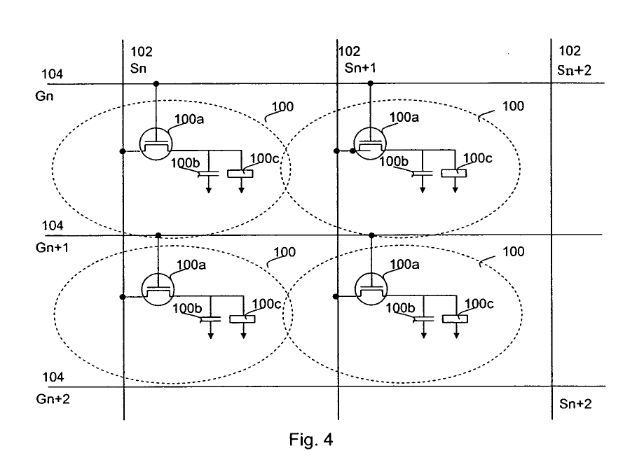

FIG. 4 illustrates several pixel cells 100 within a display panel 8 of a touch screen 6. Each pixel cell 100 may represent one pixel.

The pixel cell 100 may be comprised of transistor 100a, capacitor 100b, and liquid crystal cell 100c.

The column selection for a pixel cell 100 may be done by activating the respective source line 102 (Source: Sn, Sn+1, Sn+2). The source lines 102 may be connected to a display controller 30 for receiving pixel data. The row selection may be done through gate line 104 (Gate: Gn, Gn+1, Gn+2, etc.) signals. Gate lines 104 may be connected to an address coding within display controller 30.

When source line 102 and gate line 104 for a particular transistor 100a are activated, the respective liquid crystal cell 100c at pixel cell 100 is activated, and the pixel cell 100c shows the image data, i.e. light intensity and color, for this respective pixel in the image.

The block diagram of the pixel cells 100 as illustrated in FIG. 4 is working as follows

Image data is input from interface 36, which source is drive engine 4, to a frame memory in the display controller 30. A timing controller within display controller 30 sends timing information to an address coding in display controller 30 which generates control signals for controlling the line selection.

A line selection within display controller 30 may read location information from the frame memory by using a latch pointer and a line pointer.

The digital image data is input to a Digital-Analog-Converter in display controller 30. The data is converted to an analog image data for a certain column 102, being represented by the source line 102.

The analog image data is also inputted to the display panel 8 for line selection. The location of each displayed pixel is controlled by an address coding block via source lines 102 and gate line 104 control signals. The gate line control signal may have digital values (‘0’ or ‘1’), which may be used for selecting a line of the pixel on the display panel 8. The pixel value of a certain column, being stored as digital information of the image data, may then be provided through source lines 102, respectively.

For a visible pixel the source line 102 and gate line 104 are activated and the displayed pixel value represents the analog value of the respective source line 102.

When illuminating one pixel cell 100c, the analog image data, i.e. the current at source line 102, can flow through transistor 100a and load charging capacitor 100b.

This loading is continued until there is selected another gate line by setting another gate line 104 HIGH.

The loading of capacitor 100b controls the brightness of liquid crystal cell 100c of the pixel cell 100. The loaded capacitor 100b keeps the analog value, i.e. the visible grey level of the pixel cell 100, until the same gate line 104 is selected again and a new loading is carried out.

The pixel cell 100, which is visible, is working as follows

Analog image data is output on the source lines 102 (Sn, Sn+1, Sn+2, etc.). A selection, which is the used gate line 104, where all pixel cells 100 are updated, is further output by setting the respective gate line HIGH.

Setting a particular gate line 104 HIGH represents selecting a corresponding line of pixel cells 100 connected thereto by respective gates of transistors 100a, which are updated at the same time. The pixel cells 100 in other lines are not updated. This update is starting on one of the edges of the display panel 8 and after the start, every next line (e.g. from Gn=>Gn+1=>Gn+2, etc.) is updated until the opposite side of the display panel 8 is reached. Then, the updating can be started from the beginning again.

When updating pixel information, the display information needs to be transferred via interface 36 from drive engine 4 to display controller 30. If a touch detection is further provided, this information needs to be transferred first to the engine 4. This causes latency, in particular when creating cursors depending on detected touches.

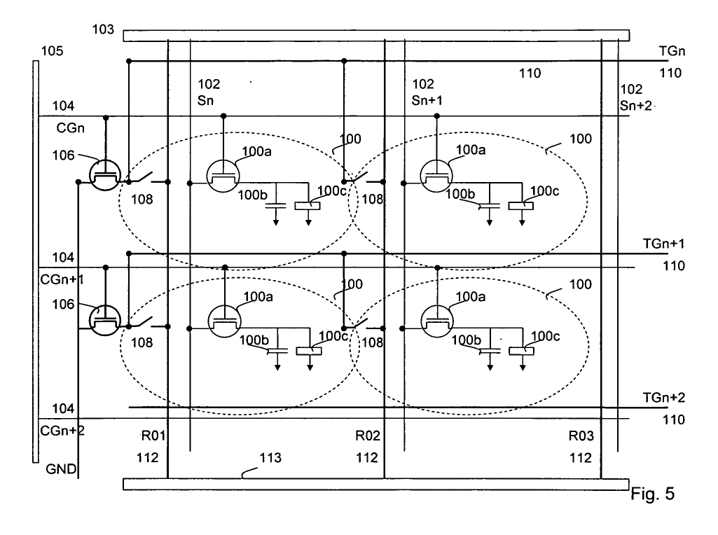

In order to allow for creation of the cursor more quickly, it may be necessary to combine touch detection and pixel updating, such that these are synchronized. The synchronization between touch detection and display update may be possible with pixel cells as illustrated in FIG. 5.

According to the arrangement of FIG. 5, touch detection information of at least one pixel cell 100 may be provided at the same time as when pixel information of the cell is updated. With this information, a source driver 103, directly arranged within the touch screen 6 may update the pixel information of the pixel cell 100 depending on the touch detection information at the time when the pixel is updated.

There are provided touch sensors 108. Touch detection information of these touch sensors may contain at least the co-ordinates of a detected touch on the display, i.e. the location of the respective pixel cell 100.

This touch detection information may be provided at the time when pixel information of the pixel cell is updated. For this reason, common gate lines 104 are provided, activating touch detection and pixel updating with a common line, e.g. synchronizing touch detection and pixel updating.

The touch detection information is provided to the source driver 103. The source driver 103 at the same time operates as a driver for updating the pixel cells 100. Receiving within the source driver 103 the touch detection information allows the touch screen 6 itself to update the pixel depending on detected touches. FIG. 5 illustrates pixel cell 100 as illustrated in FIG. 4, further comprising transistors for touch detection 106. Pixel cell 100 further comprises touch detection sensors 108.

As can be seen in FIG. 5, there are provided combined or common gate lines 104 CGn, CGn+1, etc. These common gate lines 104 provide for synchronizing pixel cell 100 updating and touch detection sensor 108 scanning, as is explained in the following:

There is provided a common gate driver 105. This gate driver 105 includes the same amount of the lines that are used for display panel 8 as illustrated in FIG. 4. These lines are indicated as common gate lines 104 CGn, CGn+1, CGn+2, etc.

When a common gate line 104 is set HIGH, the transistor 106 for touch detection is activated in the same way and time as the transistor 100a of pixel cell 100 in the same line on the display panel 8 is activated.

For detecting touches on the display panel 8, it is checked whether a touch screen sensor 108 of pixel cell 100 is depressed. That means that only for a line of cells where the CGn line 104 is active are touch sensors 108 read out.

When a common gate line 104 is HIGH, the respective line of touch detection sensors 108 is connected to GND and touch detection for this line is possible. A read out controller 113 may be connected to read out lines 112 (RO1, RO2, RO3, etc.). The state of a read out line 112 may be indicative of a state of the respective touch detection sensor 108 in the currently activated line. Thus, when a read out line 112 is at ground, and it is known, which common gate line 104 is HIGH, the respective pixel cell 100 at which a touch is detected, can be determined. The read out controller 113 may provide this information to touch screen controller 34 for further processing to the engine 4. However, the touch information may be processed in parallel within the source driver 103 for quick cursor creation.

At the same time, a HIGH common gate line 104 allows for charging the pixel cell within this line 104 through source line 102. Source lines 102 may be operated using a source driver 103. Source driver 103 is used for updating pixel cell information, i.e. for activating the respective liquid crystal cell 100c at pixel cell 100, using data stored in pixel output buffers within source driver 103.

In order to allow for quick cursor creation, embodiments provide connecting the read out lines 112 directly to source driver 103. Both read out lines 112 and source lines 102 are connected to source driver 103 and source driver 103 may address pixel cells 100 and readout touch sensors 108 simultaneously. When a common gate line 104 is activated, and a read out line 112 is at GND, it can directly be determined whether touch sensor 108 at the pixel cell 100 at the respective location is touched or not.

For quick cursor information, within source driver 103 there are provided pixel output buffers storing pixel output information for each pixel cell 100. By directly connecting the read out line 112 to source driver 103, the state of the read out lines 112 may directly influence the output from the pixel output buffers. For example, when a touch detection sensor 108 at an active pixel cell 100 is closed, i.e. the pixel cell 100 is pressed at this location, the pixel cell information within the output buffer may be altered, such that one pixel of a cursor is drawn. That means that by immediately updating the pixel information, the touch detection state of each of the touch detection sensors 108 is read within source driver 103 and the pixel information of the respective pixel cell 100 may be altered directly.

In order to create a cursor, the pixel information of the pixel cell needs to be altered. Altering pixel information of a pixel cell 100 may depend on the location of touch detection, as well as the type of cursor. According to one embodiment, a cursor may be exactly displayed at the location, where a touch is detected. In this case, it may be possible that exactly one read out line 112 has influence on the output buffer of exactly one source line 102.

It may also be possible, to illustrate “thin” cursors, by only altering pixels of one or two columns, even when touches are detected over more than two columns.

Another solution can be to illustrate a cursor at a designated source column on source line 102, even when a touch is detected within adjacent or further away pixel cells through the respective read out lines 112. For example, when a touch is detected in read out line 112 R01, a pixel cell may be altered to display a cursor within source line 102 SN+1. Also, a pixel within source line 102 SN+2 may be created upon detection of a touch within read out line 112 R01.

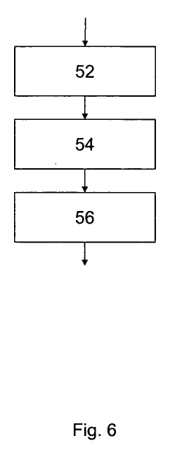

FIG. 6 illustrates a flow chart of a method according to embodiments. Display controller 30 may receive (52) display information for being displayed on display panel 8. The display information may be forwarded (54) to source driver 103, as well as common gate driver 105. Using timing information, common gate driver 105 activates consecutive common gates to update pixel cells 100 within these lines. Connected pixel cells 100 within these lines are updated according to the pixel information within source lines 102, being stored in pixel output buffers within source driver 103.

While updating (56) the pixel cells 100, source driver 103 simultaneously reads out the states of the touch detection sensors 108 of the activated common gate lines 104.

When reading out ground (GND), the touch detection sensor 108 is depressed. In this case, a part of a cursor may be displayed by the respective pixel cell 100 by changing the pixel output buffer information for this source line 102. The change of the buffer state immediately, when setting a liquid crystal cell 100c to a particular brightness, allows for direct creation of a cursor. A cursor, in most cases, is bigger than one pixel cell in size. Therefore, after detecting at least one, possibly two or more depressed states of touch detection sensors 108 in neighboring regions, display buffers within source driver 103 of more than one pixel cell 100 can be altered such that a cursor is displayed. For example, a vertical blinking line may be displayed, when one or more vertically adjacent touch detection sensors 108 are depressed and this depressing is detected in source driver 103. This line may be displayed by altering the display buffer information such that the pixel cells 100, which are vertically arranged adjacent to each other over 2-20 pixel cells 100 are display as black-white blinking cursor.

It is to be understood that source driver 103 may comprise logic for displaying various types of cursors, i.e. blinking lines, arrows or the like. It is further understood that a cursor may be displayed exactly at the pixel cell 100 position where a touch is detected, or may be moved to a pixel cell 100 where user input is required. Further, it is to be understood, that more than one pixel cell 100 may be activated for cursor display using a logic within source driver 103 for altering the pixel buffers.

Further, the source driver 103 may receive information from engine 4, indicating within which areas user input is possible. From this information source driver 103 may calculate the pixel cells 100 which can display a cursor. The source driver 103 may comprise logic to calculate the cursor within an area where user input is possible. The cursor may be calculated within such an area which is closest to a pixel cell where a touch is detected.

Further, the source driver 103 may comprise logic to determine where a cursor is displayed, even when a plurality of not adjacent pixel cells 100 indicate touch detection. For example, the logic may create the cursor at the position, where at first a touch was detected. Also, the cursor may be calculated at the position where the highest numbers of adjacent pixel cells provide touch detection information to the source driver 103.

By way of the illustrated embodiments, cursor creation is fast and easy to implement. It is not necessary to require the drive engine 4, or the touch screen controller 34 together with the display controller 30 to calculate the cursor. The cursor can be directly calculated for instance within the source driver 103.

In order to provide this functionality, the common gate driver 105, as well as a source driver 103 can be located at non-visible areas of the display panel 8.

The specification has been described above by means of exemplary embodiments. It should be noted that there are alternative ways and variations which will be evident to any person of skill in the art and can be implemented without deviating from the scope and spirit of the appended claims.

Furthermore, it is readily clear for any person skilled in the art that the logical blocks in the schematic block diagrams as well as the flowchart and algorithm presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. The computer software may be stored in a variety of storage media of electric, magnetic, electromagnetic or optic type and may be read and executed by a processor, such as for instance a microprocessor. To this end, the processor and the storage medium may be coupled to interchange information, or the storage medium may be included in the processor.

1. A method, comprising:
providing touch detection information of a pixel cell at a time when pixel information of the pixel cell is updated, and
updating pixel information of the pixel cell depending on the touch detection information at the time when the pixel information is updated.

2. The method of claim 1, wherein providing touch detection information comprises providing the touch detection information to a source driver.

3. The method of claim 1, wherein updating pixel information of the pixel cell comprises updating information within a pixel output buffer.

4. The method of claim 1, further comprising synchronizing touch detection and pixel updating such that at one time instance touch detection is enabled and pixel cells are updated within a same set of pixel cells.

5. The method of claim 4, wherein said synchronizing comprises combining at least a pixel selection line and a touch detection line within one common gate line.

6. The method of claim 3, wherein said updating the pixel information of the pixel cell within a pixel output buffer comprises changing the pixel information such that the pixel shows at least a part of a cursor.

7. The method of claim 1, further comprising arranging a source driver responsive to said touch detection information within a non-visible area of a display.

8. The method of claim 1, further comprising changing pixel output buffers of at least one neighboring pixel cell of a first pixel cell when a touch is detected within the first pixel cell.

9. The method of claim 1, further comprising changing pixel output buffers of pixel cells in a circular vicinity of a first pixel cell when a touch is detected within the first pixel cell.

10. The method of claim 1, further comprising providing a source driver with information about first pixel cells, where user input is possible and further changing a pixel output buffer of at least one pixel cell of the first pixel cells, which is closest to said at least one pixel cell where a touch is detected.

11. The method of claim 4, wherein a cursor shape is generated with at least one of
A) a line shape,
B) an arrow shape,
by changing pixel output buffers of pixel cells which are spatially arranged according to the cursor shape.

12. An apparatus, comprising:
a touch screen,
a driver within the touch screen,
wherein the driver is connected to a touch detection sensor,
wherein the driver is connected to at least one pixel cell, and
wherein the touch detection information is read out from the touch detection sensor by the driver at a time when pixel information of the pixel cell is updated,
wherein the driver updates pixel information of the pixel cell within a storage depending on the touch detection information at the time when the pixel information is updated.

13. A device, comprising:
touch detection means arranged within pixel cells of a touch screen for detecting touches within the pixel cells,
driving means for driving source lines of the touch screen such that the driving means are connected to the touch detection means,
wherein the driving means are connected to at least one pixel cell, and
wherein the touch detection means are read out by the driving means at the time when pixel information of the pixel cell is updated,
wherein the driving means update pixel information of the pixel cell within a storage means depending on the detected touches at a time when the pixel information is updated.

14. A computer-readable medium having a computer program stored thereon, the computer program comprising:
instructions operable to cause a processor to
provide touch detection information of a pixel cell to a driver at a time when pixel information of the pixel cell is updated, and
update pixel information of the pixel cell within a storage depending on the touch detection information at the time when the pixel information is updated.
